(19) United States
(12) Patent Application Publication
(10) Pub. No.: US 2011/0051457 A1
(43) Pub. Date: Mar. 3, 2011

(54) CEILING MOUNT LED LAMP

(76) Inventor: Chih-Ming CHEN, Taipei County (TW)

(21) Appl. No.: 12/814,958

(22) Filed: Jun. 14, 2010

(30) Foreign Application Priority Data
Aug. 28, 2009 (CN) 200920182700.1

(51) Int. Cl. F21V 7/22

(52) U.S. Cl. 362/607; 362/606

(57) ABSTRACT

A ceiling mount LED lamp is provided. The ceiling mount LED lamp includes a securing unit, and a lighting unit. The securing unit includes a frame body, a back plate, a top plate, and a plurality of holding strips. The back plate is positioned at an opposite side of the frame body. The top plate is positioned on the back plate. The holding strips are provided at periphery inner sides of the securing unit. The holding strips have a U-shaped cross-section. The lighting unit is positioned between the frame body and the back plate of the securing unit. The lighting unit includes a reflective sheet, at least one circuit board, a plurality of LED units, a light guide plate, and a diffusion sheet. The ceiling mount LED lamp has a simple structure and can be conveniently assembled and disassembled. Further, it is cheap and suitable for mass production.

### BACKGROUND OF THE INVENTION

1. Field of the Invention

The present invention relates generally to a lamp, and more particularly, to an LED lamp adapted to be mounted on a ceiling.

2. The Prior Arts

Currently, luminaries mounted on ceilings are often used in home or offices. Such luminaries typically include chandeliers and ceiling mount fluorescent lamps. Generally, a typical chandelier often occupies a large space. When such a chandelier is provided in a home with a 2.7 m floor height, the space may be looked crowd and discordant. As to office used lamps, in most circumstances, ceiling mount fluorescent lamps are selected. A typical ceiling mount fluorescent lamp adapted for office use is a fluorescent lamp tube secured in a frame. Specifically, the frame is a flat metal-made π-shaped structure. The fluorescent lamp tube is secured inside the space defined in the frame, and a rectifier is secured on a backside of the frame or inside the space of the frame. Both of the foregoing luminaries disadvantageously consume much energy, and do not satisfy the demand of environmental protection.

LED lamps have the advantage of power saving. However, LED lamps are not yet applied in the field of ceiling mount lamps. As such, it is desired to develop a ceiling mount LED lamp for satisfying the demand of environmental protection.

### SUMMARY OF THE INVENTION

Accordingly, a primary objective of the present invention is to provide a ceiling mount LED lamp.

The present invention provides a ceiling mount LED lamp. The ceiling mount LED lamp includes a securing unit, and a lighting unit.

The securing unit includes a frame body, a back plate, a top plate, and a plurality of holding strips. The back plate is positioned at an opposite side of the frame body. The top plate is positioned on the back plate. The holding strips are provided at periphery inner sides of the securing unit. The holding strips have a U-shaped cross-section. The U-shaped cross-section of the holding strips defines receiving recesses of the holding strips.

The lighting unit is positioned between the frame body and the back plate of the securing unit. The lighting unit includes a reflective sheet, at least one circuit board, a plurality of LED units, a light guide plate, and a diffusion sheet.

The reflective sheet is disposed on the top plate of the securing unit. The at least one circuit board is provided at at least one lateral side of the reflective sheet. The LED units are distributed on the circuit board. The light guide plate is disposed on the reflective sheet for transmitting light emitted from the LED units and reflected by the reflective sheet. The diffusion sheet is disposed on the light guide plate, for diffusing the light outputted from the light guide plate.

According to an aspect of the embodiment, the lighting unit includes two or more circuit boards provided at two or more lateral sides of the reflective sheet respectively. In this case, the light guide plate is positioned between the two or more circuit boards.

Edges of the reflective sheet, the circuit board, the light guide plate and the diffusion sheet of the lighting unit are received and held in the receiving recesses of the holding strips of the securing unit, such that the reflective sheet, the circuit board, the light guide plate, and the diffusion sheet of the lighting unit are secured between the frame body and the back plate of the securing unit. The securing unit further includes a power adaptor coupled to the circuit board.

In accordance with the foregoing embodiment, the present invention provides a ceiling mount LED lamp. The ceiling mount LED lamp has a simple structure and can be conveniently assembled and disassembled. Further, it is cheap and suitable for mass production. Furthermore, the present invention advantageously applies LED units in ceiling mount lamps to achieve a higher brightness and better energy efficiency. Comparing with the conventional light sources, the ceiling mount LED lamp of the present invention saves about 60% of power, and further has the advantages of no UV and IR radiation, no flickering, no stroboflash, and quick start.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view of a ceiling mount LED lamp according to an embodiment of the present invention;

FIG. 2 is an exploded view of the ceiling mount LED lamp according to an embodiment of the present invention; and

FIG. 3 is a cross-sectional view of the ceiling mount LED lamp according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

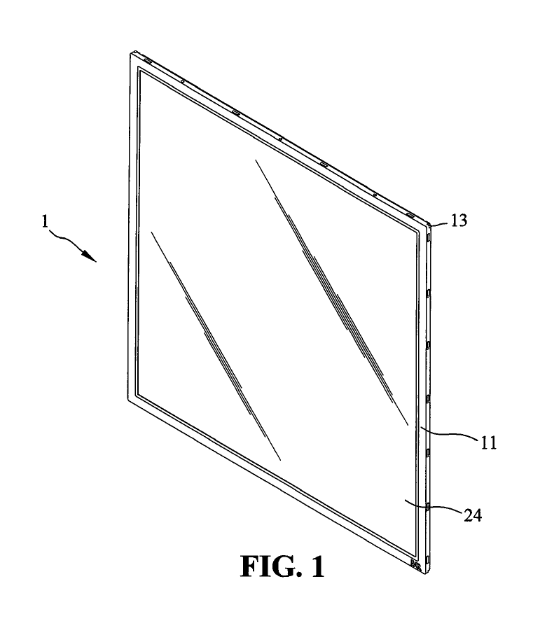

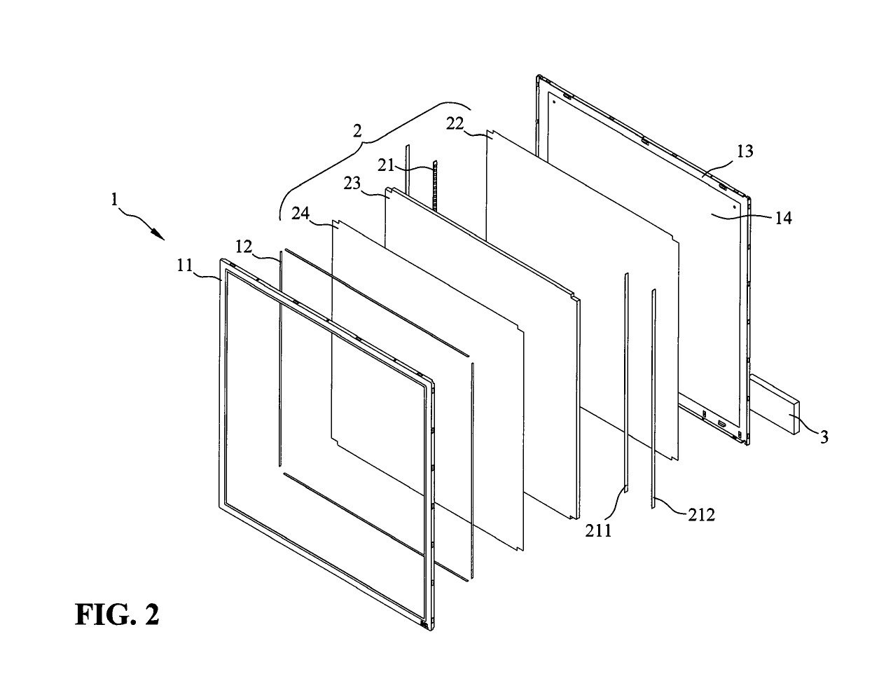

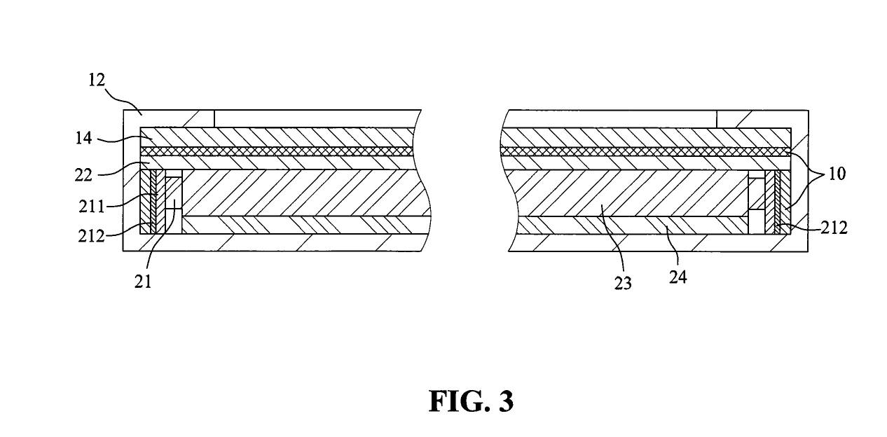

FIG. 1 is a perspective view of a ceiling mount LED lamp according to an embodiment of the present invention. FIG. 2 is an exploded view of the ceiling mount LED lamp according to an embodiment of the present invention. FIG. 3 is a cross-sectional view of the ceiling mount LED lamp according to an embodiment of the present invention.

Referring to FIGS. 1 through 3, the ceiling mount LED lamp includes a securing unit 1, and a lighting unit 2.

The securing unit 1 includes a frame body 11, a back plate 13, a top plate 14, and a plurality of holding strips 12. The back plate 13 is positioned at an opposite side of the frame body 11. The top plate 14 is positioned on the back plate 13. The holding strips 12 are provided at periphery inner sides of the securing unit 1. The holding strips 12 have a U-shaped cross-section. The U-shaped cross-section of holding strips 12 defines receiving recesses of the holding strips 12.

The lighting unit 2 is positioned between the frame body 11 and the back plate 13 of the securing unit 2. The lighting unit 2 includes a reflective sheet 22, at least one circuit board 211, a plurality of LED units 21, a light guide plate 23, and a diffusion sheet 24.

The reflective sheet 22 is disposed on the top plate 14 of the securing unit 1. The at least one circuit board 211 is provided at at least one lateral side of the reflective sheet 22. The LED units 21 are distributed on the circuit board 211. The light guide plate 23 is disposed on the reflective sheet 22 for transmitting light emitted from the LED units 21 and reflected by the reflective sheet 22. The diffusion sheet 24 is disposed on the light guide plate 23, for further diffusing and softening the light outputted from the light guide plate 23.

According to an aspect of the embodiment, the lighting unit 2 includes two or more circuit boards 211 provided at two or more lateral sides of the reflective sheet 22 respectively. In this case, the light guide plate 23 is positioned between the two or more circuit boards 211.

Edges of the reflective sheet 22, the circuit board(s) 211, the light guide plate 23, and the diffusion sheet 24 of the lighting unit 2 are received and held in the receiving recesses of the holding strips 12 of the securing unit 1, such that the reflective sheet 22, the circuit board(s) 211, the light guide plate 23, and the diffusion sheet 24 of the lighting unit 2 are secured between the frame body 11 and the back plate 13 of the securing unit 1. The securing unit 1 further includes a power adaptor 3 electrically coupled to the circuit board(s) 211.

The LED units 21 are disposed on one side of the circuit board 211 of the light unit 2, and at least one heat dissipating strip 212 is provided on an opposite side of the circuit board 211 for facilitating to dissipate heat generated by the circuit board 211 and the LED units 21.

Each circuit board 211 includes two electrodes configured at an end thereof. Wires are provided for coupling the two electrodes of the circuit board 211 with two output terminals of a power adapter 3. The power adapter 3 is coupled with an external power source (not shown in the drawings). Preferably, each of the circuit boards is further provided with a reflective strip (not shown in the drawings) for reflecting any light transmitted from the light guide plate 23 thereto.

In accordance with the embodiment of the present invention, the LED units 21 consume direct current (DC) power, and correspondingly the power adapter 3 is adapted for converting an alternating current (AC) power into a DC power in accordance with the demand of the LED units 21.

The circuit board 211 contains a printed circuit. The printed circuit may be serially coupled, parallel coupled, or serial-parallel hybrid coupled in accordance with demand of the practical power, current and voltage.

The frame body 11 is made of a metal plate. The reflective sheet 22 is made of polyethylene terephthalate (PET) or polycarbonate (PC) material, and is adapted for reflecting and scattering the light transmitted from the LED units 21 and light guide plate 23. The diffusion sheet 24 is preferably made by coating a mixture of a transparent resin and a light diffusing material on a PET substrate, or rolling with a roller on a PC substrate to form an uneven and coarse surface. The light guide plate 23 is a polymethyl methacrylate (PMMA) plate, i.e., a particularly treated organic glass. In addition, a heating dry ink or a UV ink (diffusion and reflection characterized SiO2/TiO2) is printed by a screen printing process to form a dot array on a reflective side of the light guide plate 23. The provision of the dot array destroys the total reflection of the light guide plate 23, and diffuses the light inputted therein, thus achieving a diffuse reflection and outputting a uniformed light from an outputting surface of the light guide plate 23. The dots of the dot array are preferably distributed in a manner of varying from a smaller density to a greater density and from a smaller size to a greater size.

The light guide plate 23 is adapted for transmitting while repetitively reflecting and deflecting the light emitted from the LED units 21, such that the light guide plate 23 serves as a flat light source. The diffusion sheet 6 shelters the dots and uniforms the light, and therefore, the ceiling mount LED lamp is adapted to emit a uniformed and softened light.

In accordance with the foregoing embodiment, the present invention provides a ceiling mount LED lamp. The ceiling mount LED lamp has a simple structure and can be conveniently assembled and disassembled. Further, it is cheap and suitable for mass production.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A ceiling mount LED lamp, comprising:
a securing unit, comprising:
a frame body;
a back plate, positioned at an opposite side of the frame body;
a top plate, disposed on the back plate; and
a plurality of holding strips, provided at periphery inner sides of the securing unit, wherein the holding strips have a U-shaped cross-section, and the U-shaped cross-section of the holding strips defines receiving recesses of the holding strips; and
a lighting unit, positioned between the frame body and the back plate of the securing unit, the lighting unit comprising:
a reflective sheet, disposed on the top plate of the securing unit;
at least one circuit board, provided at at least one lateral side of the reflective sheet;
a plurality of LED units, distributed on the circuit board for emitting a light, wherein the light emitted from the LED units is adapted to be reflected by the reflective sheet; and
a light guide plate, disposed on the reflective sheet for transmitting light emitted from the LED units and reflected by the reflective sheet,
wherein edges of the reflective sheet, the circuit board and the light guide plate of the lighting unit are received and held in the receiving recesses of the holding strips of the securing unit, such that the reflective sheet, the circuit board, and the light guide plate, of the lighting unit are secured between the frame body and the back plate of the securing unit.

2. The ceiling mount LED lamp as claimed in claim 1, further comprising a diffusion sheet disposed on the light guide plate for diffusing the light outputted from the light guide plate.

3. The ceiling mount LED lamp as claimed in claim 1, further comprising a heat dissipating strip disposed on one side of the circuit board opposite to the LED units.
